(19) United States
(12) Patent Application Publication
(10) Pub. No.: US 2016/0034211 A1
(43) Pub. Date: Feb. 4, 2016

(54) MEMORY SYSTEM AND INFORMATION PROCESSING DEVICE

(71) Applicant: Kabushiki Kaisha Toshiba, Minato-ku (JP)

(72) Inventor: Takeyuki MINAMIMOTO, Urayasu (JP)

(73) Assignee: Kabushiki Kaisha Toshiba, Minato-ku (JP)

(21) Appl. No.: 14/621,692

(22) Filed: Feb. 13, 2015

Related U.S. Application Data
(60) Provisional application No. 62/032,795, filed on Aug. 4, 2014.

(51) Int. Cl. G06F 3/06; G06F 12/02

(52) U.S. Cl. CPC G06F 3/0619; G06F 12/0246; G06F 3/0688; G06F 3/0655; G06F 3/061; G06F 3/065

(57) ABSTRACT

According to an embodiment, a memory includes OS startup data, an OS and user data, and a program for copying the OS startup data, the OS, and the user data onto another memory system. In a case of a read-only mode, when receiving a read command for the OS startup data from the host device, a controller reads the program stored in the memory and transmit the program to a host device.

### CROSS-REFERENCE TO RELATED APPLICATIONS

This application is based upon and claims the benefit of priority from U.S. Provisional Patent Application No. 62/032,795, filed on Aug. 4, 2014; the entire contents of which are incorporated herein by reference.

### FIELD

Embodiments described herein relate to a memory system and an information processing device.

### BACKGROUND

An memory system such as a Solid State Drive (SSD) mounted on an information processing device such as a Personal Computer (PC) stores Operation System (OS) data. Such a type of memory system prevents the data from corrupting and protects the data near the end of the life by shifting the mode to a read-only mode (hereinafter, referred to as an “RO mode”) and preventing data from being written into the embedded memory.

On the other hand, the information processing device operates by starting the OS stored in the mounted memory system. However, an OS is generally built on the assumption that data can be written into the memory system. Thus, there is a possibility in the information processing device having the memory system shifted to the RO mode that the operation of the OS can be unstable, for example, the OS does not start.

### BRIEF DESCRIPTION OF THE DRAWINGS

FIG. 1 is a block diagram of the configuration of an information processing device according to the first embodiment.

FIG. 2 is a flowchart of an outline of the process at the start of the information processing device.

FIGS. 3A and 3B are conceptual diagrams of the memory area that a host device can read from the memory system.

FIG. 4 is a flowchart of the process in the memory system when a read command is received from the host device.

FIGS. 5A to 5C are conceptual diagrams of the flow of a process for copying data from the memory system shifted to the RO mode (migration process).

FIG. 6 is a flowchart of an process for operating an OS according to a second embodiment.

### DETAILED DESCRIPTION

According to one embodiment, the memory system includes a memory and a controller. The memory includes OS startup data, an OS and user data, and a program for copying the OS startup data, the OS, and the user data onto another memory system. The controller transfers data between a host device and the memory. In a case of a read-only mode, the read-only mode supporting only a read operation of read and write operations to the memory, when receiving a read command for the OS startup data from the host device, the controller reads the program stored in the memory and transmit the program to the host device.

The memory system and information processing device according to the embodiments will be described in detail with reference to the appended drawings. Note that the present invention is not limited to the embodiments.

### First Embodiment

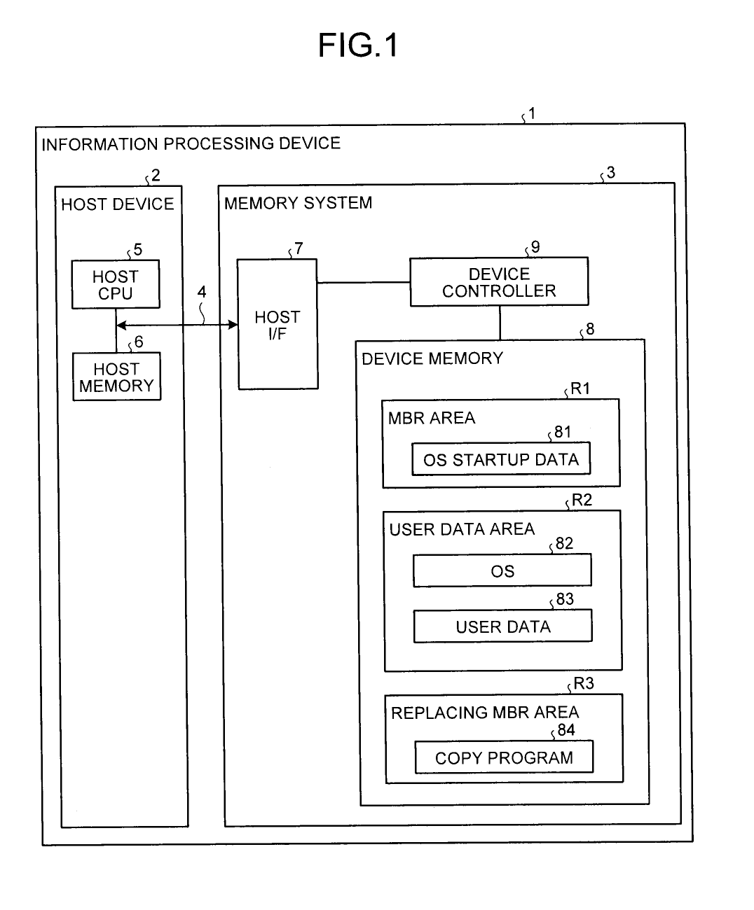

FIG. 1 is a block diagram of the configuration of an information processing device 1 according to the first embodiment. As illustrated in the drawing, the information processing device 1 includes a host device 2, and a memory system 3. The host device 2 is connectable to the memory system 3 through a communication channel 4. The information processing device 1 is, for example, a personal computer, a mobile phone, or an imaging device. The memory system 3 functions as an external storage device of the host device 2.

The host device 2 includes a host CPU (Central Processing Unit) 5 and a host memory 6. The host CPU 5 executes an OS 82 or application program loaded in the host memory 6. The OS 82 is stored in the memory system 3. The OS 82 is loaded from the memory system 3 and stored in the host memory 6 at the start of the information processing device 1. The application program is stored in the memory system 3 or another memory system so as to be loaded to the host memory 6 at the start of the application program. The host CPU 5 transmits a write command to the memory system 3, for example, in order to store the data generated by the execution of the OS 82 or the application program in the memory system 3. The host CPU 5 transmits a read command to the memory system 3, for example, in order to load the OS 82, the application program, or user data 83 from the memory system 3.

The memory system 3 is, for example, an SSD or a Hard Disk Drive (HDD). The memory system 3 includes an host interface (referred to as a “host I/F) 7, a device memory 8, and a device controller 9. The host I/F 7 is an interface between the host device 2 and the memory system 3. The host I/F 7 is connected to the host CPU 5 and the host memory 6 through the communication channel 4.

The device memory 8 is a nonvolatile memory, for example, a NAND type flash memory. The device memory 8 includes one or more memory chips including a memory cell array. The memory cell array is formed of a plurality of memory cells arranged in a matrix. Each of the memory cell arrays is formed of a plurality of blocks that is a unit of data erasing. Each of the blocks includes a plurality of pages. Each of the pages is a unit of data writing and data reading. Note that the device memory 8 can be a Magnetoresistive Random Access Memory (MRAM), a Resistance Random Access Memory (ReRAM), or a magnetic disk.

The device memory 8 includes a Master Boot Record (MBR) area R1 as the first memory area, a user data area R2 as the second memory area, and a replacing MBR area R3 as the third memory area. OS startup data 81 is stored in the MBR area R1. OS startup data 81 includes a boot loader that starts the OS 82. The OS 82, the user data 83, and the like are stored in the user data area R2. A copy program 84 is stored in the replacing MBR area R3. The copy program 84 is a program starting without the OS 82. The copy program 84 includes a function for copying the OS startup data 81 stored in the MBR area R1, OS 82 and user data 83 stored in the user data area R2 onto a memory system (not illustrated in the drawings) other than the memory system 3.

Some of the functions of the device controller 9 are implemented with an arithmetic device (CPU) and firmware. The firmware is stored in the device memory 8 or another memory in the memory system 3. The firmware is loaded to a memory in the device controller 9 and executed by the arithmetic device at the start of the memory system 3. In this way, the device controller 9 is started.

The device controller 9 is connected to the host I/F 7 and the device memory 8. The device controller 9 has a function for transferring data between the host device 2 and the device memory 8 through the communication channel 4. When receiving a write command from the host device 2, the device controller 9 writes the data to the areas R1 to R3 in the device memory 8 according to the write command. When receiving a read command from the host CPU 5, the device controller 9 reads the data stored in the areas R1 to R3 in the device memory 8 to transmit the data to the host memory 6 according to the read command.

when an RO mode shift condition is met, the device controller 9 shifts the memory system 3 to the RO mode in which data is prevented from being written to the device memory 8 and is allowed only to be read. The RO mode shift condition is met, for example, when the number of available free blocks in the device memory 8 is equal to or lower than a threshold, or when the number of bad blocks that are not used as a storage area, for example, because of many errors is equal to or higher than a threshold. The device controller 9 switches the areas R1 to R3 that the host device 2 can read in the device memory 8 depending on whether the memory system 3 is in the RO mode or not.

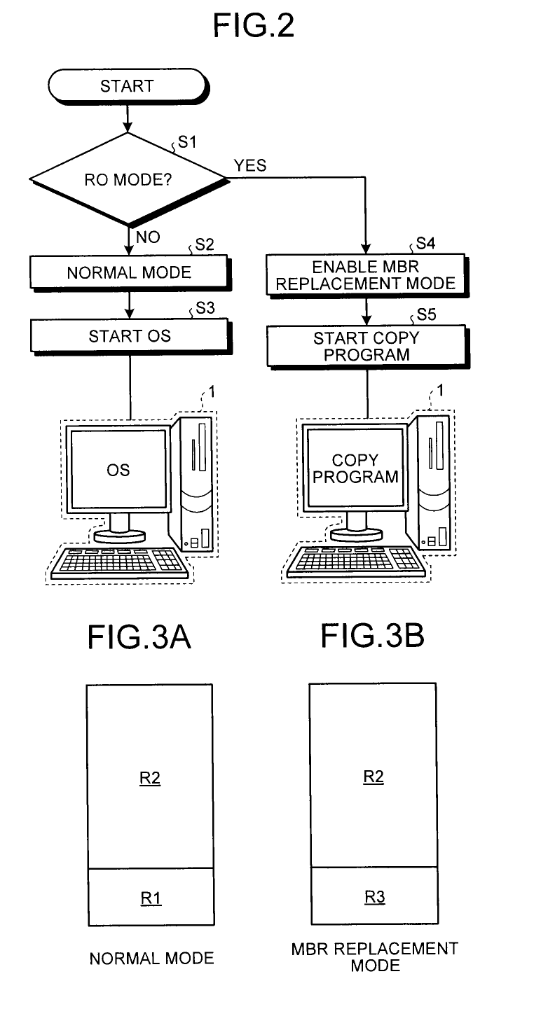

FIG. 2 is a flowchart of an outline of the process at the start of the information processing device 1. FIGS. 3A and 3B are conceptual diagrams of the memory area that the host device 2 can read from the memory system 3. When the memory system 3 is started, the process descried above is performed and the device controller 9 is started. The device controller 9 determines whether the RO mode shift condition is met (step S1). When determining that the RO mode shift condition is not met and data can be read and written (step S1: NO), the device controller 9 shifts the memory system 3 to a normal mode (step S2). In the normal mode as illustrated in FIG. 3A, the MBR area R1 and the user data area R2 are provided as the memory space to the host device 2 among the areas R1 to R3 in the device memory 8. In the normal mode, the host device 2 is allowed to read and write data in the MBR area R1 and the user data area R2.

When the memory system 3 is started in the normal mode, the host CPU 5 subsequently loads the OS 82 stored in the user data area R2 to the host memory 6 to start the OS 82 (step S3). Specifically, the host CPU 5 issues a read command for the MBR area R1 to the memory system 3. When receiving the read command, the device controller 9 reads the OS startup data 81 from the MBR area R1 in the device memory 8 to transmit the read OS startup data 81 to the host device 2. The host CPU 5 obtains the address of the device memory 8 in which the OS 82 is stored based on the OS startup data 81. The host CPU 5 issues a read command for the obtained address. When receiving the read command, the device controller 9 reads the OS 82 from the user data area R2 in the device memory 8 to transmit the read OS 82 to the host device 2. The host CPU 5 loads the OS 82 to the host memory 6 to start the OS 82.

On the other hand, when the RO mode shift condition is met (step S1: YES), the device controller 9 enables an MBR replacement mode to operate according to the MBR replacement mode (step S4). In the MBR replacement mode, when the host device 2 sends a read request for the MBR area R1 in the device memory 8, reading for the MBR area R1 is not performed and reading for the replacing MBR area R3 is performed. In other words, in the MBR replacement mode, a reading process in which the read address for the MBR area R1 is replaced by the read address for the replacing MBR area R3 is performed. Note that the range of the logical address corresponding to the MBR area R1 is predetermined. It is determined whether the read request is for the MBR area R1 or not by the logical address included in the read request from the host device 2. When the MBR replacement mode is enabled, the user data area R2 and the replacing MBR area R3 are provided as the address space to the host device 2 among the areas R1 to R3 as illustrated in FIG. 3B. Then, the host device 2 is allowed to read the user data area R2 and the replacing MBR area R3. After that, a copy program 84 stored in the replacing MBR area R3 is read from the device memory 8 and loaded to the host memory 6. As a result, the copy program 84 is started (step S5). The detail will be described below.

The OS 82 is configured on the assumption that data can be written into the device memory 8 in which the OS 82 is stored. Accordingly, when the MBR replacement mode is not enabled while the RO mode shift condition is met, data write processing to the device memory 8 is impossible although the OS 82 is loaded to the host memory 6. This causes a hang-up of the OS 82.

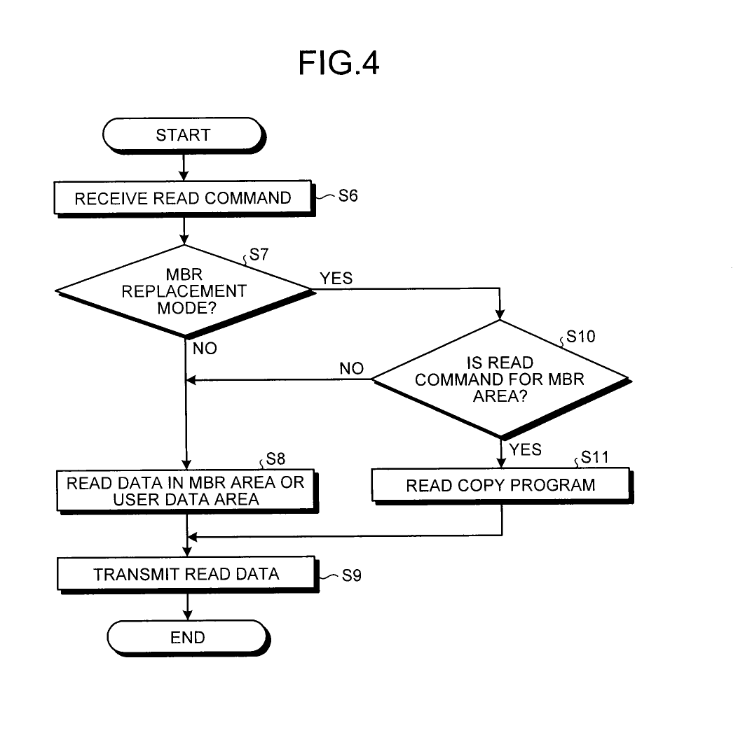

FIG. 4 is a flowchart of the process in the memory system 3 when a read command is received from the host device 2. When receiving a read command from the host CPU 5 (step S6), the device controller 9 determines whether the MBR replacement mode is enabled (step S7) or not. When determining that the MBR replacement mode is disabled (step S7: NO), the device controller 9 reads the data stored in the MBR area R1 if the read command is for the MBR area R1, or reads the data stored in the user data area R2 if the read command is for the user data area R2 (step S8). The device controller 9 transmits the data that has been read as described above to the host memory 6 (step S9).

When the MBR replacement mode is enabled (step S7: YES), in other words, when the RO mode shift condition is met, the device controller 9 determines whether the read command from the host CPU 5 is for the MBR area R1 or not (step S10). When determining that the read command is for the MBR area R1 (step S10: YES), the device controller 9 reads the copy program 84 from the replacing MBR area R3 (step S11) to transmit the copy program 84 to the host memory 6 (step S9).

Alternatively, the memory system 3 is sometimes shifted to the RO mode after the host CPU 5 starts the OS 82. In that case, the device controller 9 enables the MBR replacement mode. Accordingly, when receiving the read command for the data in the user data area R2 from the host CPU 5 (step S6), the device controller 9 determines that the MBR replacement mode is enabled (step S7: YES), and determines that the read command is not for the MBR area R1 but for the user data area R2 (step S10: NO). Then, the device controller 9 reads the data stored in the user data area R2 according to the read command (step S8) to transmit the read data to the host memory 6 (step S9).

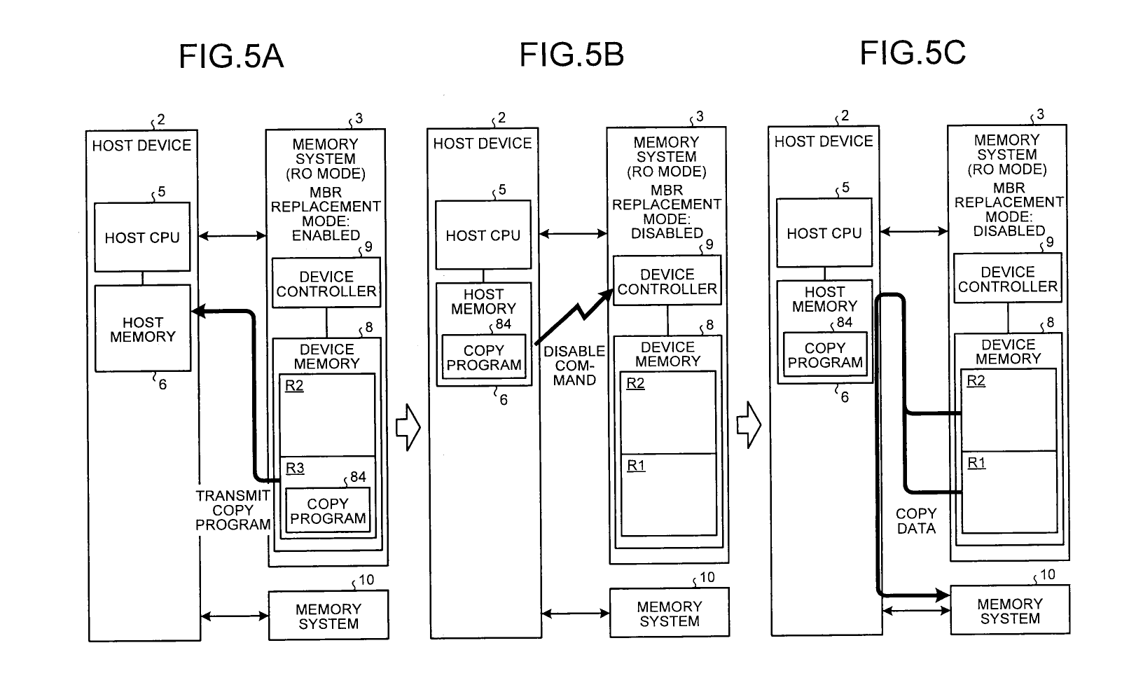

FIGS. 5A to 5C are conceptual diagrams of the flow of a process for copying data from the memory system 3 shifted to the RO mode (migration process). As illustrated in FIG. 5A, the memory system 3 is in the RO mode and the MBR replacement mode is enabled. In this state, when receiving the read command for the MBR area R1 from the host CPU 5, the device controller 9 reads the copy program 84 from the replacing MBR area R3 and transmits the copy program to the host device 2 as illustrated in FIG. 4. When receiving the copy program 84, the host CPU 5 loads the copy program 84 to the host memory 6. The copy program 84 is an embedded program and does not use a service from the OS 82. The copy program 84 has a function for copying the OS startup data 81 stored in the MBR area R1, and the OS 82 and user data 83 stored in the user data area R2 to another memory system 10, and a function for switching the MBR replacement mode of the memory system 3 from the enabled state to a disabled state.

Next, as illustrated in FIG. 5B, the host CPU 5 starts the copy program 84 loaded in the host memory 6. The copy program 84 is loaded instead of the OS 82 in the host memory 6 such that the copy program 84 is automatically started, similarly to the OS 82. When being started, the copy program 84 first sends the user a message such as “the SSD has been shifted to the RO mode. The data and OS in the SSD will be copied. Connect another storage device to the host device.” Furthermore, the copy program 84 transmits a disable command for switching the MBR replacement mode of the memory system 3 from the enabled state to a disabled state to the memory system 3. When receiving the disable command, the device controller 9 disables the MBR replacement mode even in the RO mode and configures the settings for the memory system 3 such that the host CPU 5 is allowed to read the MBR area R1. When the MBR replacement mode is disabled, the memory areas in the device memory 8 that the host CPU 5 can read are the MBR area R1 and the user data area R2 as illustrated in FIG. 3A.

After that, when the connection of the other memory system 10 to the host device 2 is detected, the copy program 84 reads the readable data stored in the MBR area R1 and the user data area R2 to copy the read data onto the memory system 10 through the host memory 6 as illustrated in FIG. 5C. When the copy of the data as described above is completed, the copy program 84 sends the user a message urging the user to replace the memory system 3 that is the copy source with the memory system 10 and restart the information processing device 1. When the user removes the memory system 3 that is the copy source and embeds the memory system 10, and restarts the information processing device 1, the OS 82 can normally be started from the memory system 10 to which the data has been copied. Accordingly, the first embodiment can readily and surely implement the migration process for the data including the data relating to the OS 82 in the memory system 3 at the end of the life while saving the user time and trouble.

The first embodiment reads the copy program 84 stored in the replacing MBR area R3 and transmits the program to the host device 2 when a read request for the OS startup data 81 stored in the MBR area R1 from the host device 2 is detected while the RO mode is met. Accordingly, the first embodiment can readily copy the data stored in the MBR area R1 and user data area R2 in the device memory 8 shifted to the RO mode onto the memory system 10 without separately preparing a host device that is for copying the data and normally operates.

### Second Embodiment

The memory system and information processing device in the second embodiment have the same configurations as in the first embodiment. Accordingly, the same reference signs are put to the same components in the second embodiment as in the first embodiment and the overlapped descriptions will be omitted. In the second embodiment, a function is added to an OS 82 in order to implement an effective operation of the migration function for the data in the memory system 3.

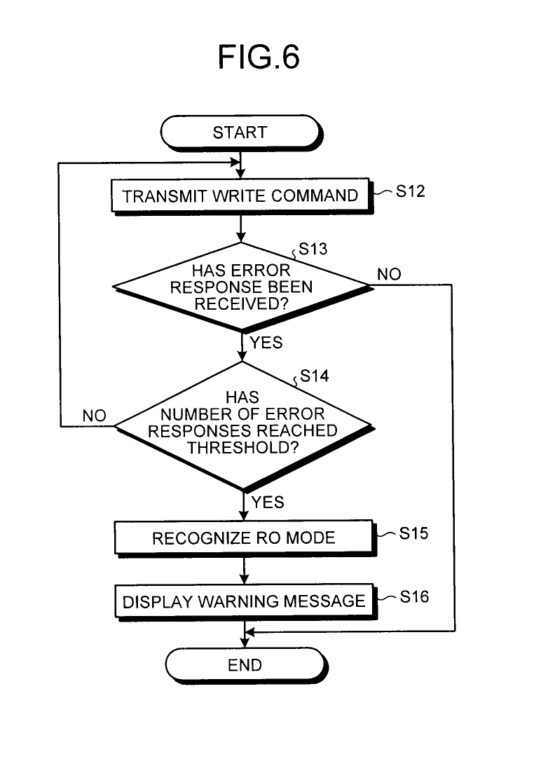

FIG. 6 is a flowchart of a process for operating the OS 82 according to the second embodiment. It is assumed that the OS 82 is normally started and the application program can normally be operated in the host device 2. It is assumed in this state that the RO mode shift condition for the memory system 3 is met while the information processing device 1 in which the host device 2 accesses the memory system 3 to read or write the data is in operation. When the memory system 3 is shifted to the RO mode, the MBR replacement mode is enabled and the memory system 3 sends an error as the response to the write command from the host device 2.

After the OS 82 transmits the write command (step S12), when the OS 82 receives a normal response from the memory system 3 (step S13: NO), the OS 82 completes the process for the write command. When receiving an error response from the memory system 3 (step S13: YES) after transmitting the write command (step S12), the OS 82 determines whether the number of receptions of error response reaches a threshold (step S14). The OS 82 transmits a write command to the memory system 3 until the number of receptions of error response reaches the threshold (step S14: NO).

When the number of receptions of error response from the memory system 3 reaches the threshold or more (step S14: YES), the OS 82 recognizes that the memory system 3 has been shifted to the RO mode (step S15). The OS 82 displays a warning message urging the user to connect the memory system 10 to the host device and restart the information processing device 1 such as the SSD has been shifted to the RO mode. The data and OS of the SSD will be copied. Connect another storage device and restart” on the host device 2 (step S16). The warning message is displayed on a monitor (not illustrated in the drawings) in the host device 2 to be recognized by the user.

As described above, in the second embodiment, the OS 82 sends the user a message urging to connect another storage device and restart when the shift of the memory system 3 to the RO mode is detected while the information processing device 1 is in operation. This enables the user to readily perform the migration process for the data by performing the process and operation according to the message while saving the user time and trouble in the second embodiment.

Note that, although detecting the shift to the RO mode when the number of receptions of error response reaches the threshold in the above description, the OS 82 can detect that the memory system 3 has been shifted to the RO mode based on various management data notified to the host device 2 from the memory system 3, or can detect that the memory system 3 has been shifted to the RO mode by receiving the information directly indicating that the memory system 3 has been shifted to the RO mode.

While certain embodiments have been described herein, these embodiments have been presented by way of example only, and are not intended to limit the scope of the present invention. Indeed, the novel embodiments described herein may be embodied in a variety of other embodiments; furthermore, various omissions, substitutions and changes in the form of the embodiments described herein may be made without departing from the spirit of the invention. The accompanying claims and their equivalents are intended to cover such embodiments or modifications as would fall within the scope and spirit of the invention.

What is claimed is:

1. A memory system comprising:
a memory including OS startup data, an OS, user data, and a program for copying the OS startup data, the OS, and the user data onto another memory system; and
a controller configured to
transfer data between a host device and the memory, and
in a case of a read-only mode, the read-only mode supporting only a read operation of read and write operations to the memory, when receiving a read command for the OS startup data from the host device, read the program stored in the memory and transmit the program to the host device.

2. The memory system according to claim 1, wherein the memory includes a first memory area in which the OS startup data is stored, a second memory area in which the OS and the user data are stored, and a third memory area in which the program is stored,
in the case of the read-only mode, when the controller receives a read command for the first memory area from the host device, the controller reads the program stored in the third memory area and transmit the program to the host device.

3. The memory system according to claim 2, wherein in the case of the read-only mode, the controller operates according to a first mode, the first mode allowing reading for the second memory area and the third memory area among the first to third memory areas.

4. The memory system according to claim 3, wherein the controller operates according to a second mode when recognizing the memory as a readable and writable device, the second mode allowing reading for the first memory area and the second memory area among the first to third memory areas.

5. The memory system according to claim 4, wherein in the case of the read-only mode, the controller operates according to the second mode when receiving a disable command that disables the first mode from the host device.

6. The memory system according to claim 5, wherein, in a case where the controller operates according to the second mode,
when receiving a read command for the OS startup data from the host device, the controller reads the OS startup data stored in the first memory area and transmits the OS startup data to the host device, and
when receiving a read command for a first area the in the second memory area from the host device, the controller reads data stored in the first area and transmits the read data to the host device.

7. The memory system according to claim 6, wherein the program includes a process for transmitting the disable command from the host device to the memory system.

8. The memory system according to claim 7, wherein, in the case of the read-only mode, the controller reads a data stored in a second area in the second memory area and transmits the read data to the host device when receiving a read command for the second area from the host device.

9. The memory system according to claim 1, wherein the memory is a nonvolatile semiconductor memory.

10. The memory system according to claim 9, wherein the nonvolatile semiconductor memory is a NAND type flash memory.

11. An information processing device comprising a host device and a memory system connectable to the host device,
wherein the host device transmits a write command and a read command to the memory system, and
the memory system includes:
a memory including OS startup data, an OS, user data, and a program for copying the OS startup data, the OS, and the user data onto another memory system; and
a controller configured to
transfer data between a host device and the memory, and
in a case of a read-only mode, the read-only mode supporting only a read operation of read and write operations to the memory, when receiving a read command for the OS startup data from the host device, read the program stored in the memory and transmit the program to the host device.

12. The information processing device according to claim 11, wherein the memory includes a first memory area in which the OS startup data is stored, a second memory area in which the OS and the user data are stored, and a third memory area in which the program is stored,
in the case of the read-only mode, when the controller receives a read command for the first memory area from the host device, the controller reads the program stored in the third memory area and transmit the program to the host device.

13. The information processing device according to claim 12, wherein, in the case of the read-only mode, the controller operates according to a first mode, the first mode allowing reading for the second memory area and the third memory area among the first to third memory areas.

14. The information processing device according to claim 13, wherein the controller operates according to a second mode when recognizing the memory as a readable and writable device, the second mode allowing reading for the first memory area and the second memory area among the first to third memory areas.

15. The information processing device according to claim 14, wherein, in the case of the read-only mode, the controller operates according to the second mode when receiving a disable command that disables the first mode from the host device.

16. The information processing device according to claim 15, wherein, in a case where the controller operates according to the second mode,
when receiving a read command for the OS startup data from the host device, the controller reads the OS startup data stored in the first memory area and transmits the OS startup data to the host device, and
when receiving a read command for a first area in the second memory area from the host device, the controller reads data stored in the first area and transmits the read data to the host device.

17. The information processing device according to claim 16, wherein the program includes a process for transmitting the disable command from the host device to the memory system.

18. The information processing device according to claim 17, wherein, in the case of the read-only mode, the controller reads a data stored in a second area in the second memory area and transmits the read data to the host device when receiving a read command for the second area from the host device.

19. The information processing device according to claim 11, wherein the memory is a nonvolatile semiconductor memory.

20. The information processing device according to claim 19, wherein the nonvolatile semiconductor memory is a NAND type flash memory.
